(19) United States
(12) Patent Application Publication
(10) Pub. No.: US 2005/0116898 A1
(43) Pub. Date: Jun. 2, 2005

(54) Plasma display panel driving method

(76) Inventor: Su-Yong Chae, Suwon-si (KR)

Correspondence Address: CHRISTIE, PARKER & HALE, LLP, PO BOX 7068, PASADENA, CA, 91109-7068, US

(21) Appl. No.: 10/998,687

(22) Filed: Nov. 29, 2004

(30) Foreign Application Priority Data
Nov. 29, 2003 (KR) 10-2003-0086097

(51) Int. Cl. G09G 3/28

(52) U.S. Cl. 345/60

(57) ABSTRACT

A method for driving a plasma display panel (PDP) that includes a middle electrode formed between an X electrode and a Y electrode. A sustain discharge pulse voltage is periodically applied to the X electrode and the Y electrode in a pulse train fashion. A reset waveform, a scan pulse voltage, and a sustain discharge pulse voltage are applied to the middle electrode. In addition, the final sustain discharge pulse of the sustain discharge period is applied to any one of the X and Y electrodes, and the first sustain discharge pulse can be applied to any one of the X and Y electrodes.

### CROSS REFERENCE TO RELATED APPLICATION

This application claims priority to and the benefit of Korea Patent Application No. 10-2003-0086097 filed on Nov. 29, 2003 in the Korean Intellectual Property Office, the entire content of which is incorporated herein by reference.

### BACKGROUND OF THE INVENTION

(a) Field of the Invention

The present invention relates to a plasma display panel (PDP) driving method. More specifically, the present invention relates to a PDP driving method for improving gray scale representation performance and gray scale linearity.

(b) Description of the Related Art

Recently, liquid crystal displays (LCDs), field emission displays (FEDs), and plasma displays have been actively developed. Among the flat panel devices, the plasma displays have better luminance and light emission efficiency as compared to the other types of flat panel devices, and also have wider view angles. Therefore, the plasma displays have come into the spotlight as substitutes for the conventional cathode ray tubes (CRTs) in large displays of greater than 40 inches.

The plasma display is a flat display that uses plasma generated via a gas discharge process to display characters or images. Depending on its size, the plasma display can include tens to millions of pixels that are provided thereon in a matrix format. According to supplied driving voltage waveforms and discharge cell structures, plasma displays can be categorized into direct current (DC) plasma displays and alternating current (AC) plasma displays.

Since the DC plasma displays have electrodes exposed in the discharge space without insulation, they allow a current to flow in the discharge space while the voltage is supplied, and therefore they are problematic in that they require resistors for current restriction. On the other hand, since the AC plasma displays have electrodes covered by a dielectric layer, capacitances are naturally formed to restrict the current, and the electrodes are protected from ion shocks in the case of discharging. Accordingly, the AC plasma displays have a longer lifespan than the DC plasma displays.

FIG. 1 shows a partial perspective view of an AC PDP, and FIG. 2 shows a cross-sectional view of the PDP shown in FIG. 1.

As shown in FIGS. 1 and 2, X electrode 3 and Y electrode 4, made of transparent conductive matter and disposed over dielectric layer 14 and protection film 15, are provided in parallel and form a pair with each other under first glass substrate 11. Metallic bus electrodes 6 are respectively formed on the surfaces of X and Y electrodes 3 and 4.

A plurality of address electrodes 5 covered with dielectric layer 14′ are installed on second glass substrate 12. Barrier ribs 17 are formed on dielectric layer 14′ between address electrodes 5, and in parallel with address electrodes 5. Phosphors 18 are formed on the surface of dielectric layer 14′ between barrier ribs 17. First and second glass substrates 11,12 are provided facing each other with a discharge space 19 between first and second glass substrates 11, 12 so that Y electrode 4 and the X electrode 3 may respectively cross address electrodes 5. An address electrode of the address electrode 5 and discharge space 19 formed at a crossing part of Y electrode 4 and X electrode 3 form schematically indicated discharge cell 20.

FIG. 3 shows a conventional PDP electrode arrangement diagram. The conventional PDP electrodes have an m x n matrix configuration. Address electrodes Aₗ to Aₘ are arranged in a column direction, and Y electrodes Yₗ to Yₙ and X electrodes Xₗ to Xₙ are alternately arranged in a row direction. Discharge cell 20 shown in FIG. 3 substantially corresponds to the discharge cell 20 shown in FIG. 1.

FIG. 4 shows a conventional PDP driving waveform diagram. In a conventional PDP, one frame is divided into a plurality of subfields that are combined to express a gray scale. Each subfield according to the conventional PDP method shown in FIG. 4 includes a reset period, an address period, and a sustain period. The reset period erases wall charges formed during a previous sustain discharge, and sets up new wall charges in order to stably perform functions in a next address period. In the addressing period, the cells that are turned on and the cells that are not turned on in a panel are selected, and wall charges are accumulated on the cells that are turned on (i.e., the addressed cells). In the sustain period, discharge for actually displaying pictures on the addressed cells is performed by alternately applying a sustain discharge voltage to the X and Y electrodes.

Operations of the conventional reset period of the conventional PDP driving method will now be described in more detail. As shown in FIG. 4, the reset period includes an erase period (I), a Y ramp rising period (II), and a Y ramp falling period

(1) Erase Period (I)

While the X electrode is biased with a constant potential of Vbias, a falling ramp which slowly falls from a sustain discharge voltage of Vs to a ground potential (or 0V) is applied to the Y electrode, and the wall charges formed in the sustain period are eliminated.

(2) Y Ramp Rising Period (II)

During this period, the address electrode (not shown) and the X electrode are maintained at 0V, and a ramp voltage gradually rising from the voltage of Vs to the voltage of Vset is applied to the Y electrode. While the ramp voltage rises, a weak reset discharge is generated on all the discharge cells from the Y electrode to the address electrode and the X electrode. As a result, the (−) wall charges are accumulated on the Y electrode, and concurrently, the (+) wall charges are accumulated on the address electrode and the X electrode.

(3) Y Ramp Falling Period (III)

In the latter part of the reset period, a ramp voltage that gradually falls from the voltage of Vs to the 0V is applied to the Y electrode under the state that the X electrode maintains the constant voltage of Vbias. While the ramp voltage falls, a weak reset discharge is generated again at all the discharge cells.

In the sustain discharge period, the same sustain discharge voltage Vs is alternately applied to the X and Y electrodes to perform a sustain discharge for displaying actual images on the addressed cells. In this instance, it is desirable to apply symmetric waveforms to the X and Y electrodes during the sustain discharge period.

However, a circuit for driving the Y electrode is different from a circuit for driving the X electrode since a waveform applied to the Y electrode (a waveform for resetting and scanning is additionally applied to the Y electrode) is different from a waveform applied to the X electrode in the reset period of the conventional PDP. Accordingly, the driving circuits of the X and Y electrodes are not impedance-matched, the waveform alternately applied to the X and Y electrodes in the sustain discharge period is distorted, and a bad discharge is generated.

Also, a bad (or weak) discharge may be generated due to insufficient priming particles generated in the discharge cell when the first (or initial) sustain discharge pulse is applied after the address period in the conventional PDP.

As shown in FIG. 5, one frame (e.g., one TV field) is divided into a plurality of subfields, and the subfields are controlled by time division to thus represent gray scales. Each subfield includes a reset period, an address period, and a sustain discharge period. FIG. 5 illustrates a case in which a frame (or a TV field) is divided into eight subfields in order to realize 256 gray scales. The respective subfields SF1 to SF8 each includes a reset period (not shown), a respective address period A1, A2, A3, A4, A5, A6, A7, and A8, and a respective sustain discharge period S1, S2, S3, S4, S5, S6, S7, and S8. Sustain discharge periods S1, S2, S3, S4, S5, S6, S7, S8 have light emission periods 1T, 2T, 4T, 8T, 16T, 32T, 64T, 128T with load ratios or weights of 1:2:4:8:16:32:64:128.

For example, in order to realize the gray scale of 3, discharge cells are controlled to be discharged in the subfield SF1 with a light emission period of 1T and the subfield SF2 with a light emission period of 2T so that the summation of the discharged periods may become 3T. In like manner, the subfields with different light emission periods are combined to represent the video with 256 gray scales.

In the case of using the gray scale representation method as shown in FIG. 5 according to a conventional PDP driving method, sustain discharge pulses are respectively applied to the X and Y electrodes during the sustain period, and the gray scales are represented according to the corresponding number of sustain discharge pulses. That is, the gray scales are represented by combination of the numbers of the sustain discharge pulses applied to the respective subfields. In this instance, a conventional PDP driving method shown in FIG. 4 applies the sustain discharge pulses to the X and Y electrodes to perform a sustain discharge, and applies a reset waveform and a scan pulse voltage to the Y electrode to perform a reset function and an address function.As such, in a case of displaying the brightness of a predetermined subfield (A) by using just nine sustain discharge pulses in which the available sustain discharge pulses of the predetermined subfield are insufficient, two sustain discharge pulses are eliminated from the nine sustain discharge pulses to represent the brightness which is one degree (e.g., one period or ratio or weight) lower than that of the subfield (A) through the brightness of light waveforms which follow the seven sustain discharge pulses, and two sustain discharge pulses are added to the nine sustain discharge pulses to represent the brightness which is one degree higher than that of the subfield (A) to provide the eleven sustain discharge pulses. Two sustain discharge pulses are required for the addition or elimination and it is impossible to add or eliminate just one sustain discharge pulse because the sustain discharge pulses are alternately applied to the X and Y electrodes and the final sustain discharge pulse is applied to the Y electrode. That is, the normal reset process can be performed in the subsequent reset period only when the negative wall charges are accumulated on the Y electrode by the final sustain discharge pulse of the sustain period and the positive wall charges are maintained at the X electrode (which is biased with a ground voltage or a voltage lower than Vs). As such, it is difficult or impossible to properly represent subfields with low degrees in a conventional PDP driving method (e.g., a case in which no sustain discharge pulse is allocated to a subfield of a minimum weight and a weight which is one degree higher than the minimum weight is to be provided or when a screen load ratio of the PDP is high) is restricted (e.g., by requiring the two sustain discharge pulses), and hence, the linearity of the gray scales may be problematic.

### SUMMARY OF THE INVENTION

It is an aspect of the present invention to provide a PDP and a driving method thereof for preventing bad discharges.

It is another aspect of the present invention to provide a PDP driving method having improved gray scale representation performance and gray scale linearity.

In one exemplary embodiment of the present invention, a method for driving a PDP is provided. The PDP includes a first electrode and a second electrode to which a sustain discharge pulse is applied respectively, and a third electrode formed between the first and second electrodes, wherein one field of the PDP is divided into a plurality of subfields, the subfields are then driven, and each subfield includes a reset period, an address period, and a sustain period. The method includes: (a) applying a scan pulse voltage to the third electrode during the address period; and (b) applying a sustain discharge pulse voltage to one of the first and second electrodes during the sustain period, wherein the subfields comprise at least one first subfield for applying a final sustain discharge pulse of the sustain period to the first electrode and at least one second subfield for applying the final sustain discharge pulse of the sustain period to the second electrode.

In one exemplary embodiment of the present invention, a method for driving a PDP is provided. The PDP includes a first electrode and a second electrode to which a sustain discharge pulse is applied respectively, and a third electrode formed between the first and second electrodes, wherein one field of the PDP is divided into a plurality of subfields, the subfields are then driven, and each subfield includes a reset period, an address period, and a sustain period. The method includes: (a) applying a sustain discharge pulse voltage to one of the first and second electrodes during a sustain period of a first subfield of the subfields; and (b) applying a sustain discharge pulse voltage to the one of the first and second electrodes during a sustain period of a second subfield of the subfields, wherein the same number of sustain discharge pulses are applied to the first and second electrodes in the first subfield, and different numbers of sustain discharge pulses are applied to the first and second electrodes in the second subfield.

In one exemplary embodiment of the present invention, a method for driving a PDP is provided. The PDP includes a first electrode and a second electrode to which a sustain discharge pulse is applied respectively, and a third electrode formed between the first and second electrodes, wherein one field of the PDP is divided into a plurality of subfields, the subfields are then driven, and each subfield includes a reset period, an address period, and a sustain period. The method includes: (a) applying a sustain discharge pulse voltage to one of the first and second electrodes during a sustain period of a first subfield of the subfields with a first weight; and (b) applying a sustain discharge pulse voltage to the one of the first and second electrodes during a sustain period of a second subfield of the subfields with a second weight which is higher than the first weight, wherein the number of sustain discharge pulses applied in (b) is greater by one pulse than the number of sustain discharge pulses applied in (a) when a needed load ratio of the PDP exceeds a predetermined load ratio.

In one exemplary embodiment of the present invention, a method for driving a PDP is provided. The PDP includes a first electrode and a second electrode to which a sustain discharge pulse is applied respectively, and a third electrode formed between the first and second electrodes, wherein one field of the PDP is divided into a plurality of subfields, the subfields are then driven, and each subfield includes a reset period, an address period, and a sustain period. The method includes: (a) applying a first sustain discharge pulse to the first electrode during the sustain period of a first subfield of the subfields; and (b) applying a first sustain discharge pulse to the second electrode during the sustain period of a second subfield of the subfields.

In one exemplary embodiment of the present invention, a method for driving a PDP is provided. The PDP includes a first electrode and a second electrode to which a sustain discharge pulse is applied respectively, and a third electrode formed between the first and second electrodes, wherein one field of the PDP is divided into a plurality of subfields, the subfields are then driven, and each subfield includes a reset period, an address period, and a sustain period. The method includes: (a) applying a final sustain discharge pulse to the first electrode during the sustain period of a first subfield of the subfields; and (b) applying a final sustain discharge pulse to the second electrode during the sustain period of a second subfield of the subfields.

### BRIEF DESCRIPTION OF THE DRAWINGS

The accompanying drawings, together with the specification, illustrate exemplary embodiments of the present invention, and, together with the description, serve to explain the principles of the invention:

FIG. 1 shows a perspective view of a conventional PDP;

FIG. 2 shows a cross-sectional view of the PDP shown in FIG. 1;

FIG. 3 shows a conventional PDP electrode arrangement diagram;

FIG. 4 shows a conventional PDP driving waveform diagram;

FIG. 5 shows a conventional PDP gray scale representation method;

FIG. 6 shows a PDP electrode arrangement diagram according to certain exemplary embodiments of the present invention;

FIG. 7 shows a PDP driving waveform diagram according to a first exemplary embodiment of the present invention;

FIGS. 8A to 8E show wall charge distribution diagrams based on the driving waveform according to the first exemplary embodiment of the present invention;

FIG. 9 shows a PDP driving waveform diagram according to a second exemplary embodiment of the present invention;

FIG. 10 shows a calculation of the number of the sustain discharge pulses for each subfield when eight subfields are arranged and a total of fifty sustain discharge pulses for one TV field are respectively provided to the X and Y electrodes; and

FIG. 11 is a graph depicting the numbers of sustain discharge pulses for the respective gray scale levels according to a conventional PDP driving method and according to PDP driving methods of first and second exemplary embodiments of the present invention.

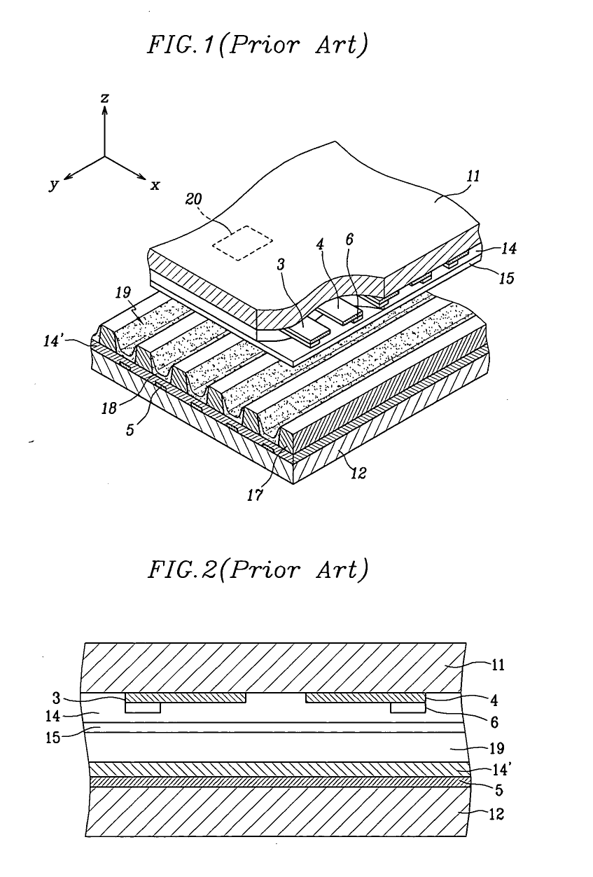

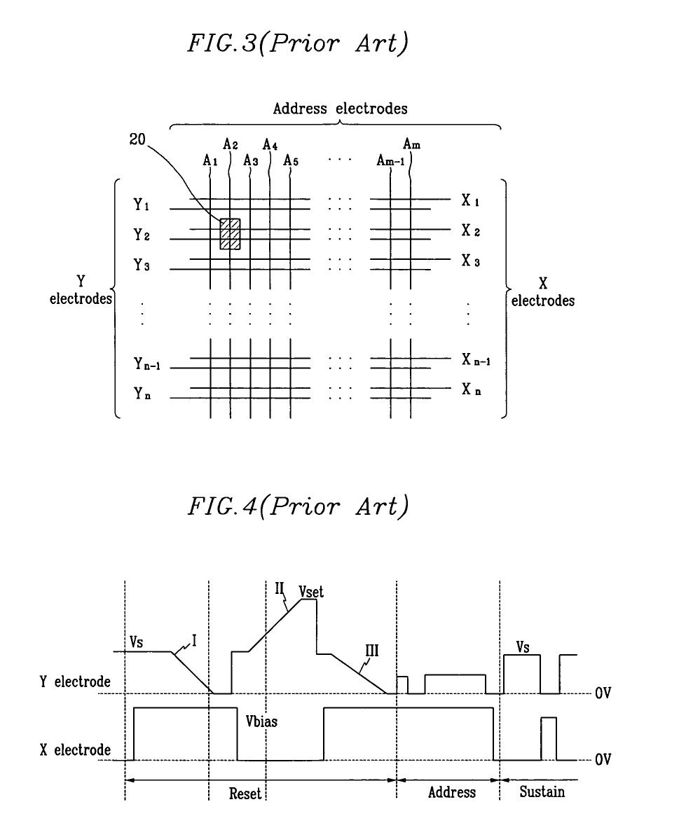

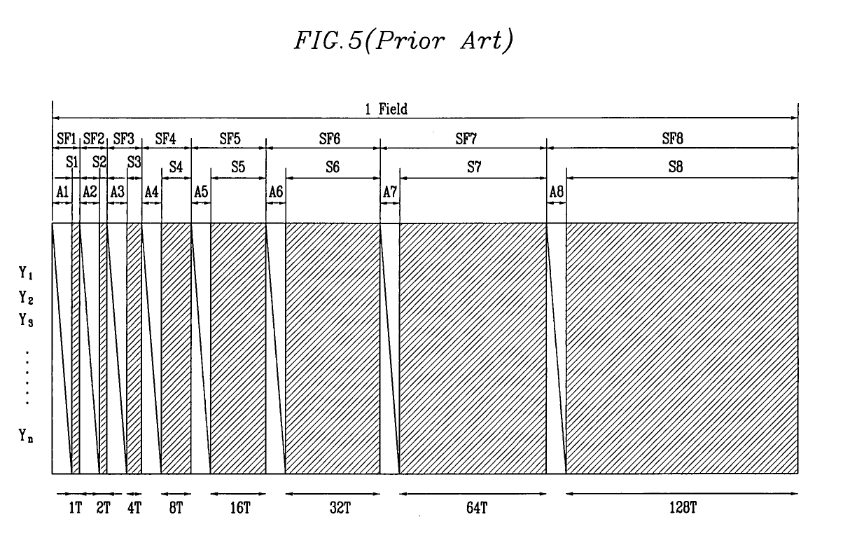

### DETAILED DESCRIPTION

In the following detailed description, only certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature, and not restrictive.

As shown in FIG. 6, a PDP includes address electrodes A_{1′} to A_{m′} arranged in parallel in the column direction, Y electrodes Y₁′ to Y_{n/2+1}′ in n/2+1 rows, X electrodes X₁′ to X_{n/2+1}′ in n/2+1 rows, and middle electrodes (referred to as M electrodes hereinafter) in n rows. That is, the M electrodes are arranged in the middle of the Y and X electrodes. The Y electrode, the X electrode, the M electrode, and the address electrode provide a four-electrode structure to form single discharge cell 30.

The X and Y electrodes function as electrodes for applying sustain discharge voltage waveforms, and the M electrodes function as electrodes for applying a reset waveform and a scan pulse voltage.

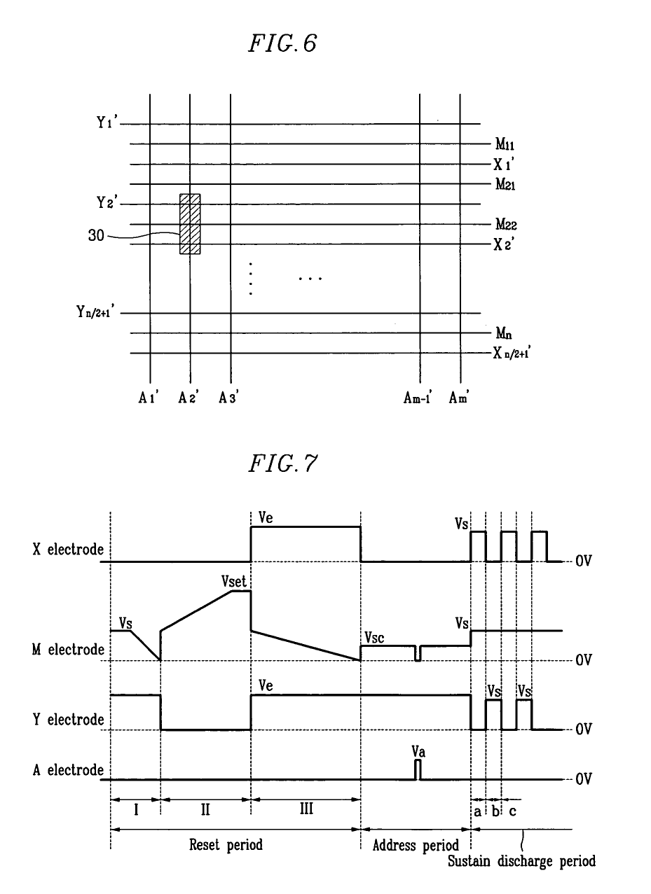

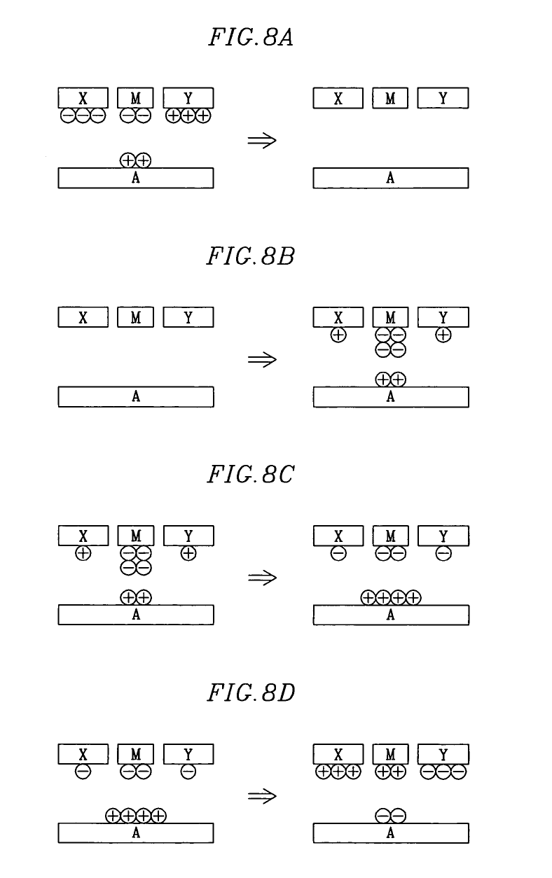

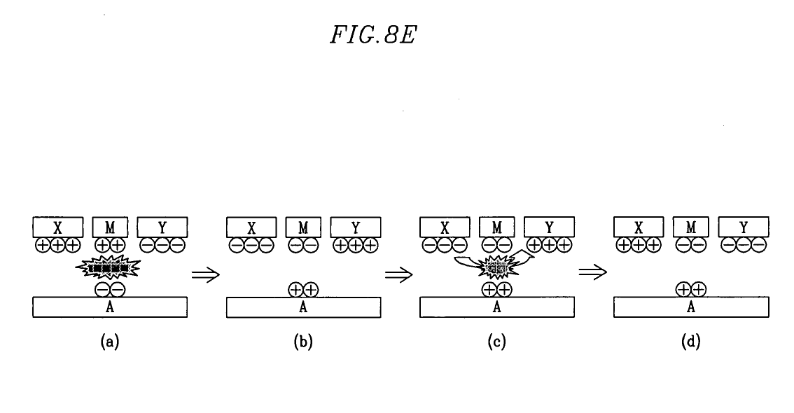

FIG. 7 shows a PDP driving waveform diagram according to a first exemplary embodiment of the present invention, and FIGS. 8A to 8E show distribution diagrams of wall charges based on the driving waveform shown in FIG. 7.

A driving method according to the first exemplary embodiment will now be described with reference to FIGS. 7, and 8A to 8E.

Each subfield includes a reset period, an address period, and a sustain period (or a sustain discharge period) according to the driving method shown in FIG. 7.

The reset period includes an erase period (I), an M electrode rising waveform period (II), and an M electrode falling waveform period (III).

(1) Reset Period

(1-1) Erase Period (I)

In the erase period, the wall charges formed during a previous sustain discharge period are erased. Assuming that a sustain discharge voltage pulse (e.g., having a voltage of Vs) is applied to the X electrode and a voltage (e.g., a ground voltage) which is lower than the voltage applied to the X electrode is applied to the Y electrode at the last point of the sustain discharge period, (+) wall charges are formed on the Y electrode and the address electrode and (−) wall charges are formed on the X electrode and the M electrode, as shown in FIG. 8A.

In the erase period, a waveform (a ramp waveform or a logarithmic waveform) which gently falls to the ground voltage from the voltage of Vs is applied to the M electrode while the Y electrode is biased with the voltage of Ve and the X electrode and the address electrode are biased with the ground. Because of the waveform(s) and/or voltage(s) applied (e.g., to the M and Y electrodes), the wall charges formed during the sustain discharge period are erased as shown in FIG. 8A. In this instance, the voltage of Vs can correspond to the voltage of Ve, e.g., Vs=Ve, for the purpose of a circuit design; however, the first exemplary embodiment is not restricted to the correspondence (e.g., Vs can be less than Ve).

(1-2) M Electrode Rising Waveform Period (II)

In this period, a waveform (a ramp waveform or a logarithmic waveform) which gently rises to the voltage of Vset from the voltage of Vs is applied to the M electrode while the X and Y electrodes are biased with the ground voltage. At all the discharge cells, a weak reset discharge is generated from the M electrode to the address electrode, the X electrode, and the Y electrode. As a result, the (−) wall charges are accumulated on the M electrode, and the (+) wall charges are accumulated on the address electrode, the X electrode, and the Y electrode as shown in FIG. 8B.

(1-3) M Electrode Falling Waveform Period (III)

In the latter part of the reset period, a waveform (a ramp waveform or a logarithmic waveform) which gently falls to the ground voltage from the voltage of Vs is applied to the M electrode while the X and Y electrodes are biased with the voltage of Ve. A weak reset discharge is generated at all the discharge cells while the ramp voltage falls. In this instance, because the M electrode falling waveform period is a period for slowly reducing the wall charges accumulated during the M electrode rising waveform period, new wall charges can be set up for the next address period (or address discharge) as the time of the falling waveform is increased (i.e., as the gradient becomes gentle) since the reduced amount of wall charges can be precisely controlled.

When the falling waveform is applied to the M electrode, the previous wall charges accumulated on the respective electrode of all the cells are equivalently erased, the new (+) wall charges are stored on the address electrode, and the new (−) wall charges are concurrently stored on the X electrode, the Y electrode, and the M electrode, as shown in FIG. 8C.

(2) Address Period (Scan Period)

In the address period, the ground voltage is sequentially applied to the M electrodes to thus apply a scan pulse, and an address voltage is applied to the address electrodes corresponding to the cells to be discharged (i.e., turned-on cells). In this instance, the X electrode is maintained at the ground voltage, and the voltage of Ve is applied to the Y electrode (i.e., the voltage which is higher than the voltage at the X electrode is applied to the Y electrode.)

A discharge is generated between the M electrode and the address electrode, a discharge is generated between the X electrode and the Y electrode, and as shown in FIG. 8D, the (+) charges are stored at the X and M electrodes and the (−) wall charges are stored at the Y electrode and the address electrode.

(3) Sustain Discharge Period

In the sustain discharge period, a sustain discharge voltage pulse (having voltage Vs) is alternately applied to the X and Y electrodes (in a pulse train fashion) while the M electrode is biased with the sustain discharge voltage of Vs. As such, a sustain discharge is generated at the discharge cells selected in the address period through the application of the sustain discharge voltage and the sustain discharge voltage pulse.

In this instance, discharges are generated through different discharge mechanisms in the initial sustain discharge stage and the normal stage. For ease of description, the discharge which occurs at the initial part of the sustain discharge period will be referred to as a short-gap discharge period, and the discharge at the time away from the initial part (or at normal time) will be referred to as a long-gap discharge period.

(3-1) Short Gap Discharge Period

As shown in parts (a) and (b) of FIG. 8E, (+) voltage pulses are applied to the X electrode and (−) voltage pulses are applied to the Y electrode (wherein the signs of (+) and (−) represent relative concepts caused by comparing the magnitude of the voltage applied to the X with the magnitude of the voltage applied to the Y electrode, and applying the (+) pulse voltages to the X electrode represents applying a voltage which is greater than the voltage applied to the Y electrode to the X electrode and the sign of (−) does not necessarily have to be a negative voltage, i.e., a voltage below 0V) in the start period of the sustain discharge. Concurrently, the (+) voltage pulses are applied to the M electrode. Therefore, the discharges between the X electrode/M electrode and the Y electrode are generated, differing from the conventional discharge generated between the X and Y electrodes. In particular, the electrical field applied between the M and Y electrodes becomes greater since the distance between the M and Y electrodes is shorter than the distance between the X and Y electrodes. Therefore, the discharge between the M and Y electrodes performs a more dominant role than the discharge between the X and Y electrodes. Accordingly, the discharge which occurs at the initial part of the sustain discharge is called the short-gap discharge since the discharge between the M and Y electrodes with a relatively shorter distance performs the leading role in the earlier part of the sustain discharge.

As described, since the relatively higher electric field is applied at the earlier stage of the sustain discharge to generate a short gap discharge, a sufficient discharge is achieved even if insufficient priming particles may be generated in the discharge cell at the time of applying a first (or initial) sustain discharge pulse after the address period.

(3-2) Long Gap Discharge Period

Since the voltage at the M electrode is biased with a constant voltage of Vs after the first sustain discharge pulse of the sustain discharge is applied (e.g., after (a)), the discharge between the M and X electrodes or the discharge between the M and Y electrodes (i.e., the short gap discharge) has less contribution to the discharge, the discharge between the X and Y electrodes becomes the main discharge, and as a result, the input video is displayed according to the number of discharge pulses alternately applied to the X and Y electrodes.

That is, as shown in parts (c) and (d) of FIG. 8E, the (−) wall charges are consecutively stored on the M electrode, and the (−) and (+) wall charges are alternately stored on the X and Y electrodes during the sustain discharge period in the normal state.

According to the first exemplary embodiment, a sufficient discharge is performed when less priming particles are provided since the discharge is performed by the short gap discharge between the X and M electrodes (or between the Y and M electrodes) in the initial part of the sustain discharge (e.g., during the application of the initial or first discharge pulse), and a stable discharge is performed in the normal state since the discharge is performed according to the long gap discharge between the X and Y electrodes.

Also, since almost symmetric voltage waveforms (or pulse periods or pulse widths) are applied to the X and Y electrodes, substantially similar circuits for driving the X and Y electrodes can be used. Therefore, since most of the difference of the circuit impedance between the X and Y electrodes is eliminated, distortion of the pulse waveforms applied to the X and Y electrodes is reduced to allow the stable discharge during the sustain discharge period.

According to the first exemplary embodiment shown in FIG. 7, a PDP of the present invention is driven when the waveforms of the X and Y electrodes are exchanged (or mirrored), and also when the waveforms of the X and Y electrodes are exchanged (or mirrored) in the address period.

Also, according to the first exemplary embodiment, the reset waveform and the scan pulse waveform are mainly applied to the M electrode, and the sustain voltage waveform is mainly applied to the X and Y electrodes. In exemplary embodiments of the present invention, the reset waveform applied to the M electrode can be the reset waveform shown in FIG. 7, as well as other suitable reset waveforms.

Specifically, in the first exemplary embodiment and with reference to FIGS. 6 and 7, the M electrode formed between the X and Y electrodes controls the erase period, the reset period, and the address period (during which the scan pulse waveform is applied), and the X and Y electrodes control the sustain period. In this case, since the M electrode maintains the negative wall charge state during the sustain period as shown in (d) of FIG. 8E, the processes during the erase period of the reset period are normally performed irrespective of the fact that the final sustain discharge pulse of the sustain period (or a sustain discharge period) is applied to the X or Y electrode. In addition, the bias voltage applied to one of the X and Y electrodes during the erase period can be varied depending on the case of whether the final sustain discharge pulse of the sustain period is applied to the X electrode or the Y electrode.

Also, a first (or initial) sustain discharge pulse can be applied to either the X or Y electrode during the sustain period, and the voltages applied to the X and Y electrodes can be exchanged with each other. In this case, the bias voltage applied to the X and Y electrodes during the address period should also be varied. That is, in order to apply the first sustain discharge pulse to the X electrode, the Y electrode should be biased with the voltage of Ve, and in order to apply the first sustain discharge pulse to the Y electrode, the X electrode should be biased with the voltage of Ve.

A method for applying the first sustain discharge pulse voltage to the X or Y electrode and applying the final sustain discharge pulse voltage to the same, based on using the X or Y electrode to control the sustain period and the M electrode to control the erase period, will now be described in detail.

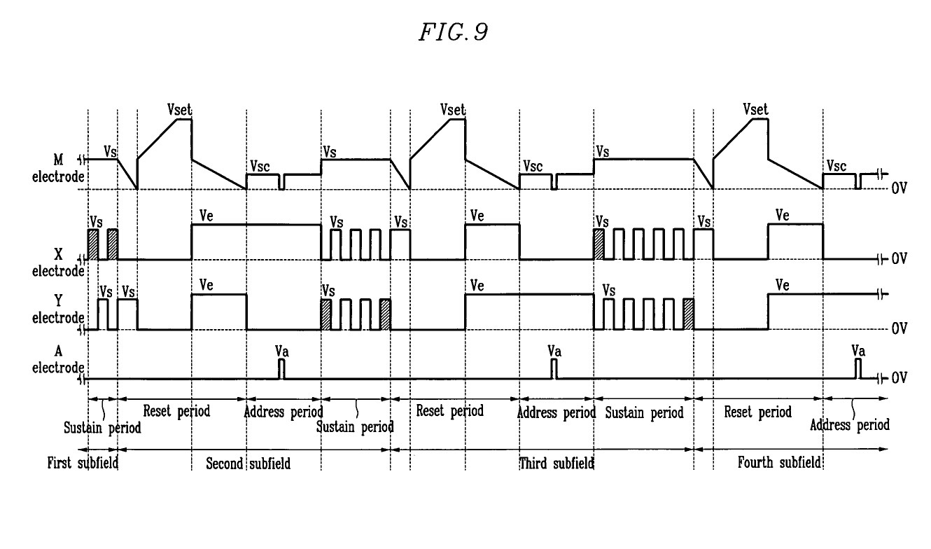

FIG. 9 shows a PDP driving waveform diagram according to a second exemplary embodiment of the present invention As shown, the driving waveform according to the second embodiment of FIG. 9 has substantially the same driving waveform of FIG. 7. In more detail, the bias voltage of Ve applied to the X or Y electrode during the address period is modified in order to apply the first sustain discharge pulse to either the X or Y electrode, and the bias voltage of Vs applied to one of the X and Y electrode is modified depending on whether the final sustain discharge pulse is applied to the X electrode or the Y electrode.

As shown in FIG. 9, the first sustain discharge pulse is applied to the X electrode and the final sustain discharge pulse is applied to the X electrode during the sustain period of the first subfield. In this instance, even though not illustrated in FIG. 9, it is needed to apply 0V to the X electrode and the voltage of Ve to the Y electrode during the address period of the first subfield in order to apply the first sustain discharge pulse to the X electrode in the sustain period of the first subfield. Also, the erase operation is performed when a constant voltage of Vs (which is variable) is applied to the Y electrode during the erase period in the reset period of the second subfield since the final sustain discharge pulse has been applied to the X electrode.

The first sustain discharge pulse is applied to the Y electrode, and the final sustain discharge pulse is applied to the Y electrode during the sustain period of the second subfield. In this instance, it is needed to apply the voltage of Ve to the X electrode and 0V to the Y electrode during the address period of the second subfield in order to apply the first sustain discharge pulse to the Y electrode. Also, the appropriate erase operation is performed when a constant voltage of Vs (which is variable) is applied to the X electrode during the erase period in the reset period of the third subfield since the final sustain discharge pulse has been applied to the Y electrode.

The first sustain discharge pulse is applied to the X electrode, and the final sustain discharge pulse is applied to the Y electrode during the sustain period of the third subfield. In this instance, it is needed to apply the voltage of Ve to the Y electrode and 0V to the X electrode during the address period in order to apply the first sustain discharge pulse to the X electrode. Also, it is required to apply a constant voltage of Vs (which is variable) to the X electrode during the erase period of the fourth subfield in order to perform an appropriate erase operation since the final sustain discharge pulse has been applied to the Y electrode.

As further shown in FIG. 9, the PDP driving method according to the second exemplary embodiment has a feature that the first sustain discharge pulse can be randomly applied to the X or Y electrode and the final sustain discharge pulse can be randomly applied to the X or Y electrode. That is, the driving methods according to the second embodiment (or the first exemplary embodiment) do not have to be bound by the condition in which the first sustain discharge pulse has to be applied to the Y electrode and the final sustain discharge pulse has to be applied to the same in the sustain period in a like manner of the prior art. Also, the number of sustain discharge pulses applied to the X electrode is different from the number of sustain discharge pulses applied to the Y electrode in the first and second subfields because of high selectivity of the electrode to which the sustain discharge pulses are applied, and the number of sustain discharge pulses (e.g., five) applied to the X electrode in the third subfield corresponds to the number of sustain discharge pulses (e.g., five) applied to the Y electrode. A method for increasing gray scale linearity and low gray scale representation performance in the case of driving the PDP will now be described.

In the PDP driving methods according to the first and second embodiments, the final sustain discharge pulse in the sustain period can be applied to either the X or Y electrodes (and the first sustain discharge pulse can also be applied to either the X or Y electrodes), and hence, when a predetermined subfield A is represented with nine sustain discharge pulses, it is possible to represent the brightness which is lower by one degree than the brightness of the subfield A by using the brightness of the light waveform caused by eight sustain discharge pulses (rather than seven discharge pulses), since the representation of the brightness degree can now be allowed with just one sustain discharge pulse rather than the two sustain discharge pulses according to the conventional PDP driving method. As a result, the increased width of the minimum brightness for each degree is reduced through the PDP driving method according to the first and second embodiments, and accordingly, more advantageous gray scale linearity is obtained.

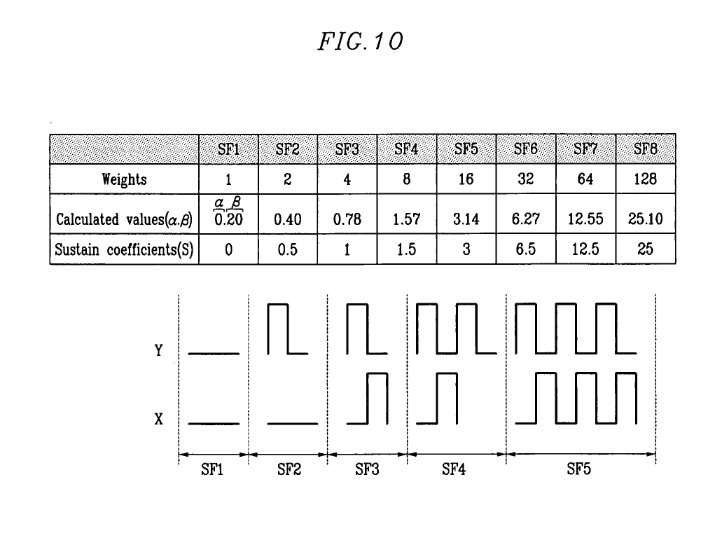

FIG. 10 shows the calculation of the number of the sustain discharge pulses for each subfield when eight subfields are arranged, and the total of fifty sustain discharge pulses for one TV field are respectively provided to the X and Y electrodes in the PDP driving methods according to the first and second embodiments. In more detail, FIG. 10 shows calculation of the numbers of sustain discharge pulses allocated to the respective subfields when the screen load ratio of the PDP is greater than a predetermined load ratio (representing the case in which the number of sustain discharge pulses of the subfield with the lowest weight is 0 or 1).

As shown in FIG. 10, a calculated value (α.β) of the number of the sustain discharge pulses of the respective subfields can be calculated by using the total number of sustain discharge pulses (i.e., fifty or 50) times the weight divided by 255 (where 0 represents the first of the 256 gray scales). That is, the calculated value (α.β) of the subfield SF2 with the weight of 2 becomes 0.4 (0.392 . . . precisely) from the calculation of 50 (the total number of sustain discharge pulses)×2/255. In addition, if the calculated value (α.β) have a value (β) after (or right of) the decimal place (.) that is greater than 0.25 and less than 0.75, one sustain discharge pulse is added to represent the brightness which corresponds to 0.5. That is, one sustain discharge pulse is applied to either the X or Y electrodes. To put it another way, when the value calculated through the weight is given to beα.β, the number of sustain discharge pulses can be obtained from Equation 1.
S=α (when β<0.25) Equation 1
S=α.5 (when 0.25≦β<0.75)
S=α+1 (when β>0.75)
where S represents the sustain coefficient of the number of sustain discharge pulses. In this instance, the case in which the sustain coefficient (S) of the number of sustain discharge pulses of FIG. 10 is 0.5 represents that the subfield SF2 with the weight of 2 is to be applied with one sustain discharge pulse to the Y electrode (or the X electrode). Further, the case in which the sustain coefficient (S) is 1 (where α=0 and β=0.78) represents that the subfield SF3 with the weight of 4 is to be applied with one sustain discharge pulse to the X electrode and one sustain discharge pulse to the Y electrode. As such, it is possible to allow the number of sustain discharge pulses allocated to the first subfield with the minimum weight when the load ratio is higher than a predetermined load ratio to be different by one from the number of sustain discharge pulses allocated to the second subfield, and allow the number difference of the sustain discharge pulses between the second and third subfields to be one. Accordingly, the gray scale linearity is improved since the final sustain discharge pulse can now be applied to either the X electrode or the Y electrode during the sustain period.

In addition, the gray scale representation performance and gray scale linearity are improved when the load ratio of the PDP is high since the final sustain discharge pulse can be applicable to either the X electrode or the Y electrode in the PDP driving methods according to the first and second embodiments.

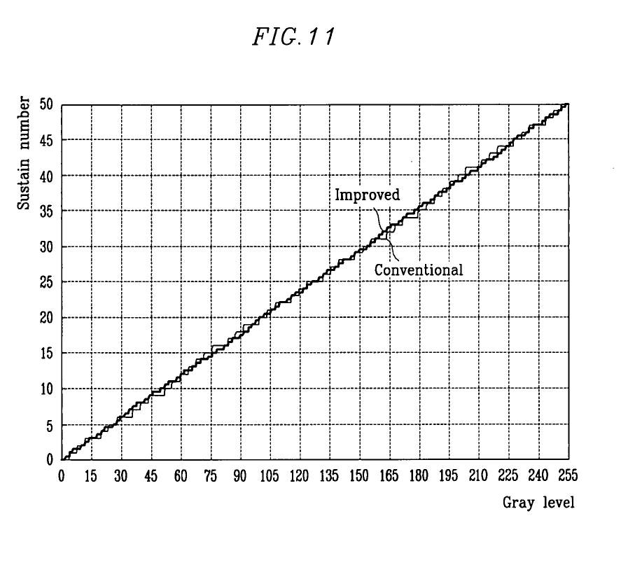

FIG. 11 shows the numbers of sustain discharge pulses for the respective gray scale levels according to the conventional PDP driving method and according to the first and second exemplary embodiments of the present invention.

As shown, the linearity of the number of the sustain discharge pulses for the respective gray scale levels according to the first and second embodiments is improved over the conventional PDP driving method.

FIG. 11 shows the case in which fifty sustain discharge pulses are provided, and 256 gray scales and eight subfields are used, which improves the gray scale linearity and gray scale representation performance since the final sustain discharge pulse can be applied to the X or Y electrode during the sustain period when the load ratio exceeds or does not match a predetermined load ratio.

In view of the foregoing, the bad discharges are prevented by forming a middle electrode between X and Y electrodes, applying a reset waveform and a scan waveform to the middle electrode, and applying a sustain discharge voltage waveform to the X and Y electrodes.

In addition, a gray scale linearity and gray scale representation performance are improved since the first and final sustain discharge pulses can be applied to either the X electrode or the Y electrode in the sustain period by applying the reset waveform and the scan pulse waveform to the middle electrode.

While this invention has been described in connection with certain exemplary embodiments, it is to be understood that the invention is not limited to the disclosed embodiments, but, on the contrary, is intended to cover various modifications included within the spirit and scope of the appended claims, and equivalents thereof.

1. A method for driving a plasma display panel (PDP) comprising a first electrode and a second electrode to which a sustain discharge pulse is applied respectively, and a third electrode formed between the first and second electrodes,
wherein one field of the PDP is divided into a plurality of subfields, the subfields are then driven, and each subfield includes a reset period, an address period, and a sustain period,
the method comprising:
(a) applying a scan pulse voltage to the third electrode during the address period; and
(b) applying a sustain discharge pulse voltage to one of the first and second electrodes during the sustain period,
wherein the subfields comprise at least one first subfield for applying a final sustain discharge pulse of the sustain period to the first electrode and at least one second subfield for applying the final sustain discharge pulse of the sustain period to the second electrode.

2. The method of claim 1, wherein the first subfield and the second subfield are provided when they have load ratios which are greater than a predetermined value.

3. The method of claim 1, wherein a voltage which has a level which corresponds to that of the sustain discharge pulse voltage is applied to the third electrode during the sustain period.

4. The method of claim 1, wherein a reset waveform is applied to the third electrode during the reset period.

5. A method for driving a plasma display panel (PDP) comprising a first electrode and a second electrode to which a sustain discharge pulse is applied respectively, and a third electrode formed between the first and second electrodes,
wherein one field of the PDP is divided into a plurality of subfields, the subfields are then driven, and each subfield includes a reset period, an address period, and a sustain period,
the method comprising:
(a) applying a sustain discharge pulse voltage to one of the first and second electrodes during the sustain period of a first subfield of the subfields; and
(b) applying a sustain discharge pulse voltage to the one of the first and second electrodes during a sustain period of a second subfield of the subfields,
wherein the same number of sustain discharge pulses are applied to the first and second electrodes in the first subfield, and different numbers of sustain discharge pulses are applied to the first and second electrodes in the second subfield.

6. The method of claim 5, wherein a first sustain discharge pulse voltage is applied to the first electrode, and a final sustain discharge pulse voltage is applied to the second electrode during the sustain period of the first subfield.

7. The method of claim 5, wherein a first sustain discharge pulse voltage and a final sustain discharge pulse voltage are applied to the first electrode during the sustain period of the second subfield.

8. The method of claim 5, wherein a final sustain discharge pulse voltage is applied to the first electrode during the sustain period of the first subfield, and a final sustain discharge pulse voltage is applied to the second electrode during the sustain period of the second subfield.

9. The method of claim 5, wherein a first sustain discharge pulse voltage is applied to the first electrode during the sustain period of the first subfield, and a first sustain discharge pulse voltage is applied to the second electrode during the sustain period of the second subfield.

10. The method of claim 5, wherein a reset waveform is applied to the third electrode during the reset period, and a scan pulse waveform is applied to the third electrode during the address period.

11. A method for driving a plasma display panel (PDP) comprising a first electrode and a second electrode to which a sustain discharge pulse is applied respectively, and a third electrode formed between the first and second electrodes,
wherein one field of the PDP is divided into a plurality of subfields, the subfields are then driven, and each subfield includes a reset period, an address period, and a sustain period,
the method comprising:
(a) applying a sustain discharge pulse voltage to one of the first and second electrodes during a sustain period of a first subfield of the subfields, the first subfield having a first weight; and
(b) applying a sustain discharge pulse voltage to the one of the first and second electrodes during a sustain period of a second subfield of the subfields, the second subfield having a second weight which is higher than the first weight,
wherein the number of sustain discharge pulses applied in (b) is greater by one pulse than the number of sustain discharge pulses applied in (a) when a needed load ratio of the PDP exceeds a predetermined load ratio.

12. The method of claim 11, wherein the second weight is higher than the first weight by one degree.

13. The method of claim 11, wherein the first weight is the lowest weight.

14. The method of claim 11, wherein the predetermined load ratio is a load ratio of when one sustain discharge pulse is applied in (a).

15. The method of claim 11, wherein the predetermined load ratio is a load ratio of when no sustain discharge pulse is applied in (a).

16. The method of claim 11, wherein a reset waveform is applied to the third electrode during the reset period, and a scan pulse waveform is applied to the third electrode during the address period.

17. A method for driving a plasma display panel (PDP) comprising a first electrode and a second electrode to which a sustain discharge pulse is applied respectively, and a third electrode formed between the first and second electrodes,
wherein one field of the PDP is divided into a plurality of subfields, the subfields are then driven, and each subfield includes a reset period, an address period, and a sustain period,
the method comprising:
(a) applying a first sustain discharge pulse to the first electrode during the sustain period of a first subfield of the subfields; and
(b) applying a first sustain discharge pulse to the second electrode during the sustain period of a second subfield of the subfields.

18. The method of claim 17, wherein the first and second subfields belong to a frame.

19. The method of claim 17, wherein the first and second subfields belong to different frames.

20. A method for driving a plasma display panel (PDP) comprising a first electrode and a second electrode to which a sustain discharge pulse is applied respectively, and a third electrode formed between the first and second electrodes,
wherein one field of the PDP is divided into a plurality of subfields, the subfields are then driven, and each subfield includes a reset period, an address period, and a sustain period,
the method comprising:
(a) applying the final sustain discharge pulse to the first electrode during the sustain period of a first subfield of the subfields; and
(b) applying the final sustain discharge pulse to the second electrode during the sustain period of a second subfield of the subfields.

21. The method of claim 20, wherein the first subfield and the second subfield belong to a frame.

22. The method of claim 20, wherein the first subfield and the second subfield belong to different frames.
